(19) United States
(12) Patent Application Publication
(10) Pub. No.: US 2003/0062990 A1
(43) Pub. Date: Apr. 3, 2003

(54) Powerline bridge apparatus

(76) Inventors: Donald Joseph Schaeffer JR., Salt Lake City, UT (US); James Russell, Sandy, UT (US); Haroon I. Yunus, Holladay, UT (US)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 10/229,391

(22) Filed: Aug. 27, 2002

Related U.S. Application Data
(60) Provisional application No. 60/316,492, filed on Aug. 30, 2001.

(51) Int. Cl. H04M 11/04

(52) U.S. Cl. 340/310.01

(57) ABSTRACT

A system whereby existing powerlines are utilized as a data transport medium whereby computer network data, audio data, video data, control signals, native communication signals, and any combinations thereof are transported via powerlines, wherein powerline access portals are provided at any electrical power outlets to thereby enable data to be transmitted onto and received from standard powerlines, and wherein filters can be installed at power boxes to ensure that data is not transported to any powerlines that are not considered part of a data network.

### CROSS REFERENCE TO RELATED APPLICATIONS

This document claims priority to, and incorporates by reference, all of the subject matter included in the patent application filed on Aug. 30, 2001, having serial No. 60/316,492.

### THE FIELD OF THE INVENTION

This invention relates generally to networking on power lines. More specifically, the invention relates to using power lines as data portals for a data network, wherein data is transmitted via power lines in order to provide new and state of the art data transport functionality without having to re-wire a building with new network cabling.

### BACKGROUND OF THE INVENTION

The scope of this document deals with topics that span various industries. This is due to the fact that the invention provides a way to use existing powerlines, in a home, business, vehicle, ship, airplane, city, robot or other object using electrical power lines, as a transport system for data. The implications of being able to provide immediate and ubiquitous data transport without having to install network-capable wiring may not be readily apparent at first. Therefore, we will explore the implications of the present invention in terms of existing data transport capabilities.

Generally when thinking of data transport, a person is likely to immediately think only of computer networks. The present invention goes far beyond this single application, but it is a good place to begin. Computer networks are obviously of increasing importance in our technology driven economy. Even in a home environment, a computer is no longer a luxury item but a necessity for children to keep pace with peers and to become comfortable with emerging technology. The state of the art in computer networks is typified by wire and wireless networking solutions.

This document is concerned with the issue of ubiquitous availability of data transport and data portals. More and more often, businesses and homeowners are confronted by the issue of how they are going provide computer connectivity to growing numbers of computers. It should be understood from the outset that there are generally two types of computer networks that are of interest in this document. The first type is a local area network or LAN. A LAN is typically implemented as a central server and a plurality of workstations that are connected to the central server through a hub or switch. The LAN enables all of the workstations to share data and computer resources, such as printers, scanners, and access to the second type of network. The second type of network is any larger global information network, such as the Internet.

The primary method of communication between the plurality of workstations and the central server is by use of the network cable. The network cable is any physical wire that is capable of carrying computer network data signals. But a physical wire is not the only medium by which computer network data can be carried. Wireless communications have been looked at as a means for overcoming the problem of having a home or business that is not pre-wired with network cables.

Consider first the wired computer network. Cabling for computer networks is generally difficult to install in an existing structure such as a home or office, and is going to be relatively expensive. Furthermore, access to certain rooms may be impossible in some locations. The user is either forced to abandon networking altogether, or move to a mixed solution, such as adding wireless networking capability.

Wireless networking may be suitable in some circumstances, but cannot be used in every situation. A home or business must be concerned about security of their network. State of the art security for wireless systems is sorely lacking, as the encryption standards are relatively simple to break, difficult to implement, or simply forgotten by the user, thus leaving the network and its data open to intruders. In addition, there are numerous situations in which other signals may interfere with the ability to provide wireless communications. For example, some frequencies of wireless communication can interfere with certain types of medical equipment. The structure of a building can also create dead zones that interfere with data transmission.

Thus, just from the aspect of computer networks, it is desirable to provide a system that enables widespread computer network access to existing structures that does not require the installation of new network cables. Those skilled in the art will appreciate that in many historic buildings; it can be difficult to lay new wiring without damaging the interior. Additionally, it should be emphasized that laying new wire in any existing building can be extremely expensive, especially if the building is old.

So far this document has addressed some of the issues that face those who need to install network cabling in existing structures. But this is only one small aspect of the invention. Consider more generic data transport that is not computer network data. For example, security systems need to transport video data. An intercom system needs to transport audio data. A television satellite signal provides both audio and video data. There are numerous examples where video, audio, and combinations of video and audio data need to be transmitted from one location to at least one other location that have not even been mentioned.

These video, audio and video/audio combinations generally do not use computer network cabling. Video is generally transported via coaxial cables, and audio only data is transported via less expensive wires. Thus, the state of the art teaches that different kinds of cables or wires must be installed for specific applications. One room may need audio wires, another room video cables, another room, computer network cabling, and another room a combination of all three.

The present invention is not limited to the problems of transporting computer network data, video data, and audio data. Control signals are a highly specialized form of data that are really not addressed by the state of the art. Control signals include signals sent from a remote control device to control a television, audio equipment, lights, etc. These control signals are commonly transported via infrared and radio frequency signals.

With the increasing use of streaming data across the Internet or other global information networks, another data type that is commonly found is that of encapsulated data. Encapsulated data can include such data types as MP3, MPEG1, MPEG2, MPEG3, MPEG4, and others.

A last type of data transport that should be mentioned before looking at the invention is transport provided by specialized cabling and protocols. Such specialized transport includes data that is transported via connections and protocols including Firewire (IEEE 1394), USB 1.0 and 2.0, serial, parallel, optical, telephony, DSL, WiFi 802.11a, 802.11b, Bluetooth, RF wireless, infra-red, and other “native” standards that are used to enable electronic appliances to communicate. These electronic appliances include such devices as camcorders, PDAs, mobile telephones, computers, Bluetooth appliances, printers, scanners, copiers, etc.

It should now be more apparent that the scope of the present invention includes general data transport, regardless of the type of protocol, the connector, the cable, the wire, the wireless system, or the control commands being used. Thus, it would be an advantage over the state of the art to provide a data transport system that would enable all types of data to be transmitted throughout a building and beyond, regardless of the presence or absence of wiring that is dedicated for any of these purposes. In essence, what is needed is a transport medium that is already in place, but simply needs the interfaces needed to send data into and retrieve data from the transport medium.

### SUMMARY OF INVENTION

It is an object of the present invention to provide a system to enable the transport of data in a building, regardless of the presence or absence of the dedicated cabling or wiring that is normally required.

It is another object to provide the system in any building that includes electrical outlets in the rooms where access to the data is required.

It is another object to provide the system wherein computer network data, video data, audio data, control signals, encapsulated data, native communication signals, and any combinations thereof can all simultaneously share the same transport medium.

It is another object to provide the system wherein the system includes the technology to safeguard the data and prevent distribution beyond a desired physical location.

It is another object to provide the system wherein the distribution limits can be easily modified if expansion or contraction of those limits is required.

In accordance with the teachings of this document, the present invention is a system whereby existing powerlines are utilized as a data transport medium whereby computer network data, audio data, video data, control signals, encapsulated data, native communication signals, and any combinations thereof are transported via powerlines, wherein powerline access portals are provided at electrical power outlets to thereby enable data to be transmitted onto and received from standard powerlines, and wherein filters can be installed at power junction boxes to ensure that data is not transported to any powerlines that are not considered part of a data network.

In a first aspect of the invention, a powerline access portal is installed at an electrical outlet, providing access to the data transport system.

In another aspect of the invention, a powerline access portal is comprised of a wall-mount unit or wall wart.

In another aspect of the invention, a powerline access portal is comprised of a power strip unit that may provide power surge suppression capabilities.

In another aspect of the invention, a powerline access portal is comprised of a desktop device.

In another aspect of the invention, a powerline access portal is comprised of an embedded unit that is disposed within a system that receives and/or transmits data of any type.

In another aspect of the invention, a powerline access portal is comprised of an integrated unit that is made an integral component of an electrical wall socket.

In another aspect of the invention, a powerline access portal includes filtering to prevent noise from a device using electrical power from entering into the powerlines and disrupting data transport.

In another aspect of the invention, a powerline access portal provides at least one computer network port, a video port, an audio port, a control signal port, a native communication signal port, or any combinations thereof.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1 is a block diagram of the elements of a first embodiment that is made in accordance with the principles of the present invention.

FIG. 2 is a perspective view of an implementation of a powerline access portal of the present invention as a wall wart.

FIG. 3 is a perspective view of an implementation of a powerline access portal of the present invention as a power strip.

FIG. 4 is a perspective view of an implementation of a powerline access portal of the present invention in combination with two devices that are coupled to a computer network.

FIG. 5 is a perspective view of an implementation of a powerline access portal of the present invention as a desktop device having a separate power brick power supply.

FIG. 6 is an illustration of a stereo system that utilizes embedded powerline access portals to distribute audio data.

FIG. 7 is a perspective view of integrated powerline access portals that are disposed within an electrical outlet.

FIG. 8 is a block diagram illustrating the physical electrical power grid of a group of homes in a typical neighborhood.

FIG. 9 is an illustration of a faceplate of a typical power junction box that would be found in a home or office.

FIG. 10 is a modified power junction box that includes a computer network switch.

FIG. 11 is a block diagram of electrical appliances that are communicating with native protocols or common protocols.

FIG. 12 is a block diagram of electrical appliances that are communicating with cross protocols.

FIG. 13 is shows a schematic of a powerline bridge integrated circuit and related components used by the powerline access portal to communicate data onto and off of a powerline used in accordance with the principles of the present invention.

FIG. 14 shows a schematic of one of the data receive buffers for filtering and modulating signals in association with the powerline bridge integrated circuit.

FIG. 15 shows a schematic of a the output filter and power amp used by the powerline bridge integrated circuit for transmitting data in accordance with the principles of the present invention.

FIG. 16 shows a schematic of the powerline bridge integrated circuit in accordance with the principles of the present invention.

FIG. 17 is a schematic of the power supply and the line interface used by the powerline bridge integrated circuit to communicate data on and off of a powerline used in accordance with the principles of the present invention.

FIG. 18 is a schematic of the surge suppressor to minimize damage to electronic equipment during electrical surges.

### DETAILED DESCRIPTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims, which follow.

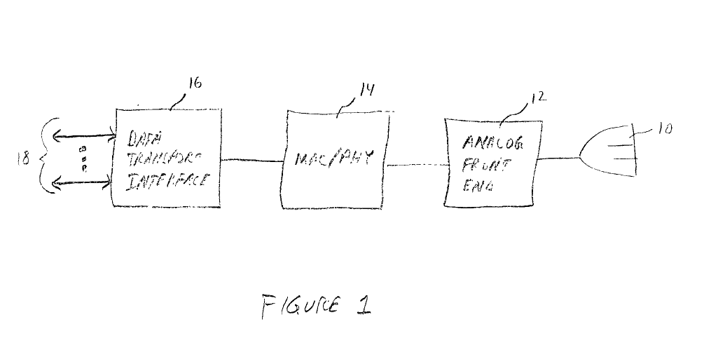

To understand the present invention in its broadest configuration, it is useful to examine a block diagram of the essential elements. FIG. 1 is a block diagram that illustrates a first embodiment of the present invention. The figure includes a powerline interface 10, an analog front end (AFE) 12, a media access controller/physical interface (MAC/PHY) 14, a data transport interface 16, and at least one connector 18 for transporting either computer network data, audio data, video data, control signals, native communication signals, or any combinations thereof.

The powerline interface 10 is simply an electrical outlet connector, which is in this case a male plug that can be coupled to a standard electrical socket. In the United States, that standard electrical socket will be carrying 110 VAC. However, this should not be considered a limiting factor because the present invention can be adapted to operate on any powerlines.

The analog front end 12 contains circuitry that is unique to the present invention. The analog front end 12 may contain amplifiers and filters. The amplifiers will boost any data signals being received from powerlines. The filters are generally going to be low pass filters. Their function in the present invention is very critical. Filters can operate in two directions. In a first case, the filters are provided in order to minimize noise being received from the powerline to which the present invention is coupled. In other words, line noise is reduced, and the data on those lines is amplified and sent on to the MAC/PHY 14.

However, a more significant use of filters and one that is not found in the industry is to provide filtering in the other direction. Thus, the present invention also provides the ability to prevent noise from entering the powerlines and disrupting data transport.

Consider dedicated cabling for a computer network. It is unprecedented in the industry that the cabling for a computer network would be contaminated by noise from electrical appliances. Category 5 cabling is shielded to prevent noise from interfering with data transport. But the present invention must contend with noise on powerlines that is on an order of magnitude more significant. Any electrical appliances drawing power will be able to introduce noise onto the same powerlines from which they draw their power. An electric drill is an example of a very “dirty” appliance that creates significant electrical noise that is fed back onto powerlines.

A helpful analogy to understand how the present invention is filtering noise can be drawn from users of DSL technology in a home environment. DSL data transport occurs on the same telephone lines that are used for analog voice signals. Each telephone has a filter that is installed between a telephone handset and a wall connector. This filter prevents noise from the telephone handset from entering the telephone lines. Similarly, the filters in the analog front end 12 also prevent noise from entering powerlines and disrupting data transport.

It is noted that another type of filtering will be discussed later in regards to physical isolation of data networks.

The MAC/PHY 14 is any industry standard processor that is capable of 1) preparing data signals for transport on powerlines, and 2) retrieving data signals that have been transmitted via powerlines. Such a processor is available from many sources. A typical example is a powerline integrated circuit manufactured by INARI of Salt Lake City, Utah, as Part No. IPL0201. Other similar processors are available.

A helpful analogy of the purpose of the MAC/PHY 14 is to consider it as the bridge between a powerline and whatever other data transport medium is being used. This interface to the other data transport medium is provided by the data transport interface 16.

The other data transport media include dedicated or specialized cabling and/or protocols. For example, the present invention is capable of transporting data for Ethernet, USB 1.0 and 2.0, parallel, serial, Firewire (IEEE 1394), optical (fiber optic), telephony, DSL, WiFi (802.11a, 802.11b, Bluetooth, and radio frequency 900 MHz), and infra-red. This list should not be considered limiting, but rather an example of the many different connectors, cables, and protocols that can be disposed onto and transported via powerlines.

Finally, FIG. 1 shows at least one physical cable 18 that represents a cable that is being used to communicate with at least one electrical device that is transmitting, receiving, or transmitting and receiving data. For example, the at least one cable 18 would be whatever cable is necessary to transport computer network data, audio data, video data, control signals, native communication signals, or any combinations thereof.

With the above explanation of the basic elements of FIG. 1, it is now possible to provide examples of how and where these elements can be implemented to advantageously provide data transport. In considering where the present invention may be used, it is useful to consider the form factor that the present invention may take. The form factors to be described are simply examples, and other similarly useful form factors may be used that are not shown hereinafter. What is important is that the form factor include the elements of FIG. 1.

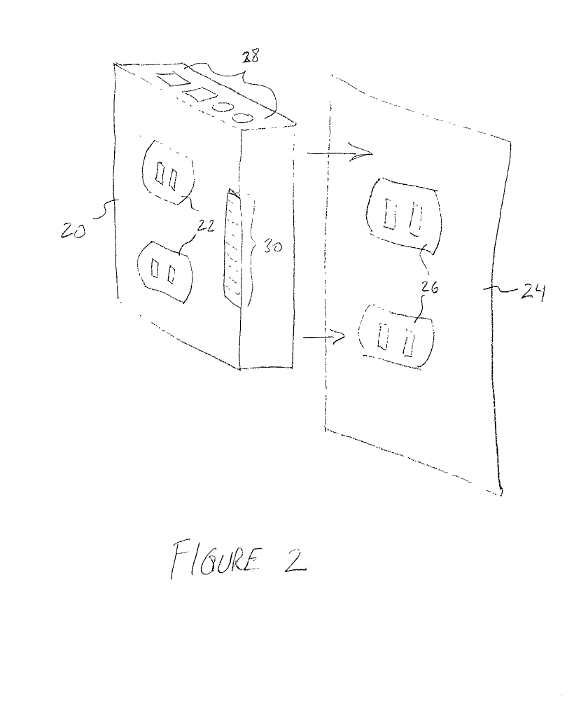

FIG. 2 is a perspective view of a wall-mounted unit 20, or wall wart as it is commonly called, of a powerline access portal. The wall-mounted unit 20 is shown having two electrical outlets 22. The wall-mounted unit 20 is plugged into a wall socket 24, also having two electrical outlets 26. Provided on top of the wall-mounted unit 20 are a plurality of data ports. Some important items to note begin with the observation that the wall-mounted unit 20 does not eliminate any electrical sockets 26. Next, by covering up the electrical outlets 26 in the wall socket 24, any electrical appliances that might be used have no choice but to be pass through the noise filters of the present invention. Thus, an electric drill may be used without interfering with data transport passing through the same wall socket 24.

It is noted that the wall-mounted unit 20 may include surge suppression circuitry. However, an industry standard surge suppression device or power strip might also be plugged into the electrical outlets 22 of the wall-mounted unit 20 and enjoy the same noise filtering benefits for all the electrical appliances that are plugged in.

The shape of the wall-mounted unit 20 should not be considered to be a limiting factor. The shape may be changed as desired. It is also possible to provide only a single electrical outlet 22 on the wall-mounted unit 20. In that case, it would be shaped so as to only cover a single electrical outlet 26 of the wall socket 24.

Another aspect of the present invention that has not been discussed is the subject of indicator lights 30. Indicator lights 30 can provide useful feedback to an observer. For example, indicator lights 30 may be comprised of a series of LEDs that provide some type of scaled indication of the degree of filtering taking place. Consider the electric drill. The indicator lights 30 would show the quantity or quality of filtering being performed. This would help an observer by first indicating whether or not filtering is taking place, and then the amount of filtering that has to be performed in order to protect data transport. This would be useful in tracking down problems with data transport if, for example, a filter was no longer functioning and large amounts of electrical noise were being introduced onto the powerlines.

The data ports 28 illustrate some important features. First, there may be a single data port or multiple data ports, depending upon the needs of the user. In addition, there may be a mixture of the types of data ports 28 that are available. The data ports 28 may provide a powerline access portal for a computer and a printer on a network, and for right and left audio channels of an audio system. It is simply important to remember that the number and type of data ports 28 should not be considered a limiting factor of the present invention or of any particular embodiment:

In addition, the placement of the data ports 28 should also not be considered a limiting factor. The data ports 28 can be disposed on the top, the side, the bottom, and even the face of the wall-mounted unit 20.

FIG. 2 clearly shows that the wall-mounted unit 20 includes at least one electrical socket 22. However, it should be noted that the wall-mounted unit does not have to include this functionality. In other words, another form factor of the present invention could also be a wall-mounted unit that is dedicated to providing data ports to a powerline, and no other function.

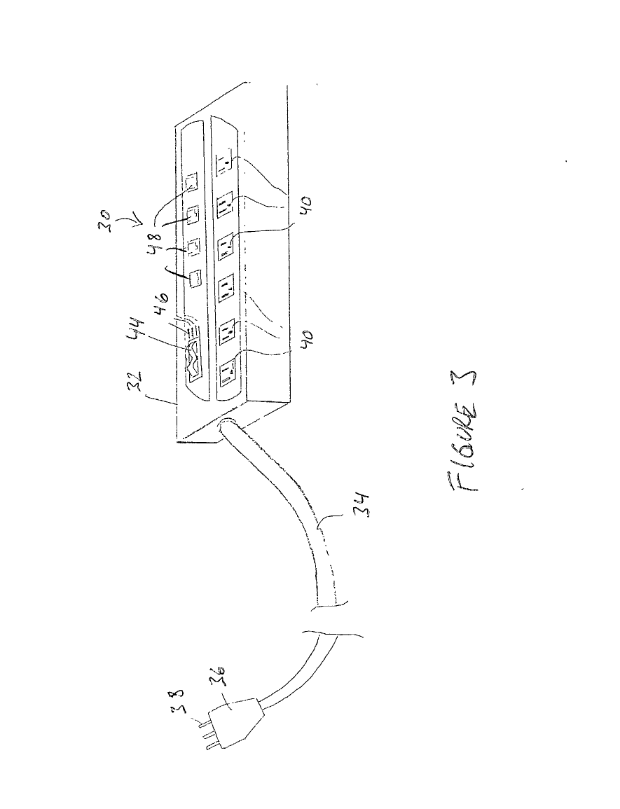

FIG. 3 is a perspective view of another form factor of the powerline access portal of the present invention implemented within a power strip/surge suppression device 32. The powerline access portal 30 includes a power cord 34, a male plug 36, prongs 38, a plurality of sockets 40, a switch 44, indicator lights 46, and a plurality of data ports 48.

This figure illustrates some important features. First, the powerline access portal can be implemented into commonly used devices such as power strips and/or surge suppressors. Second, the present invention only requires a minimal amount of space. The space requirements are such that most devices such as power strips and surge suppressors would not have to be made any larger than existing sizes. This will keep the manufacturing costs low.

One of the benefits of providing multiple data ports 46 is that the powerline access portal does not require a MAC/PHY 14 for each data port. A single MAC/PHY integrated circuit is capable of providing its service for multiple data ports.

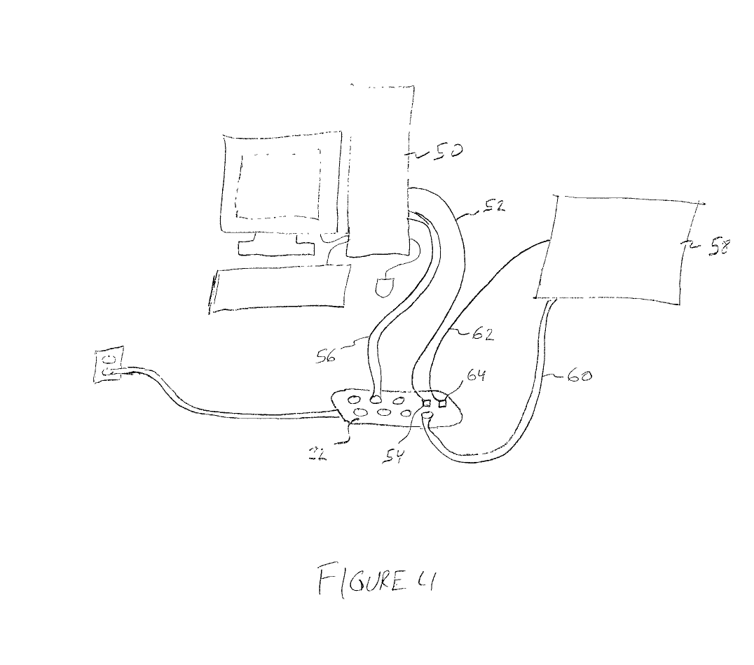

It is useful to note at least one purpose in having multiple data ports at a single data access portal device such as the power strip/surge suppression device 32. Consider FIG. 4 that shows a computer 50 that is coupled to a computer network via Ethernet cable 52 through a first data port 54 on the power strip/surge suppression device 32. A power cord 56 couples the computer 50 to the power strip 32. A user may also have a printer 58 that is capable of network operation. The printer 58 is coupled to the power strip 32 via power cord 60. The printer 58 can be made available to all users on the computer network by coupling the printer 58 to the computer network via Ethernet cable 62 through a second data port 64. This configuration has the advantage of also making a printer data port available on the computer 50. Thus, all network users can use the printer, not just the computer 50. It will be explained later in this document how the printer can function as a network printer even if it does not include computer network functionality.

It should be recognized that the power strip 32 form factor can be replaced by the wall wart of FIG. 2, and any of the others to be disclosed hereinafter.

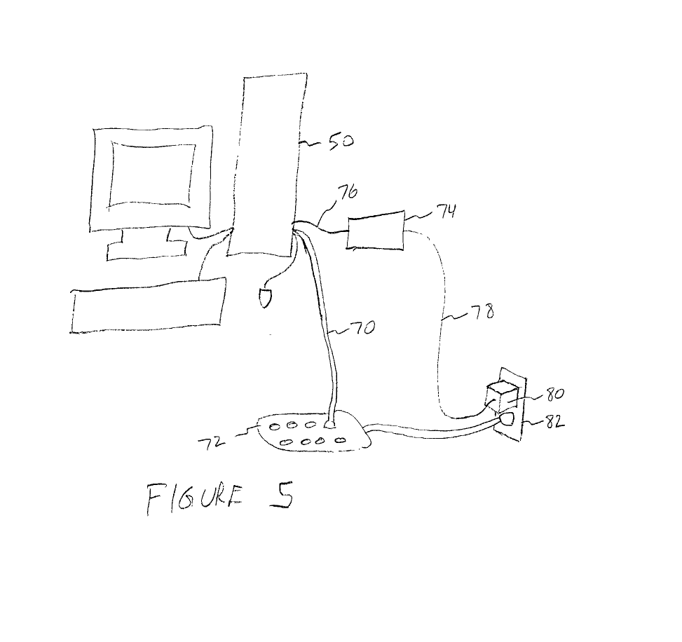

FIG. 5 is another form factor of the powerline access portal of the present invention. The computer 50 is coupled via a power cord 70 to a normal power strip 72. Access to a computer network is now provided by a desktop powerline access portal 74. The desktop powerline access portal 74 is coupled via an Ethernet cable 76 to the computer 50, and via a thin power cord 78 to a power supply 80. The power supply is plugged into wall socket 82. The power supply 82 could also be plugged into the normal power strip 72 without requiring any changes in setup or operation of the desktop powerline access portal 74. One of the benefits of this form factor comes from the use of a “power brick” type power supply 82. It is noted that the UL regulations are easier to work with for a power brick than for a powerline access portal that has the power supply as an integrated component.

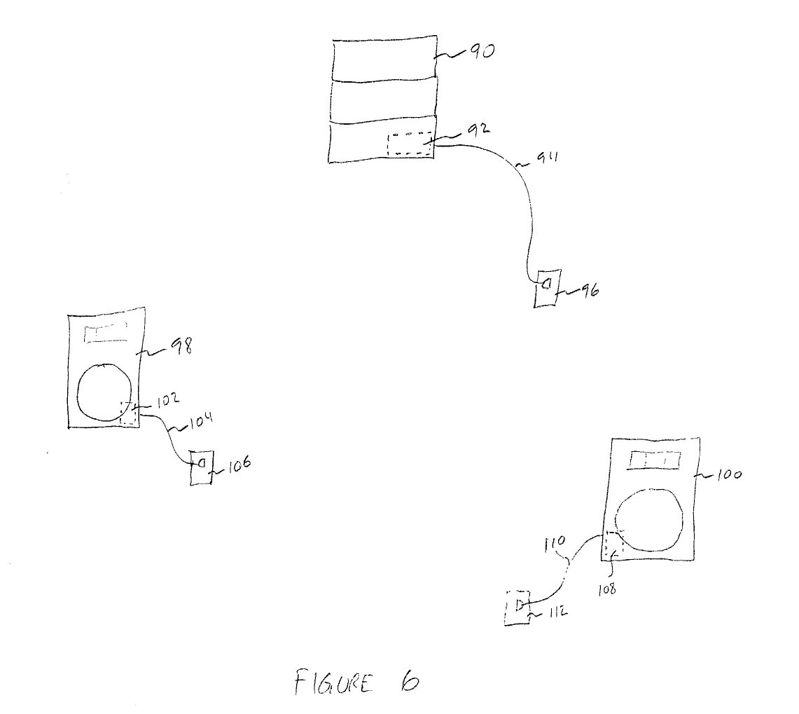

An embedded powerline access portal is the next embodiment of the present invention. An example of an embedded portal is shown in FIG. 6. It must be remembered that this is only an example, and should not be considered limiting because a powerline access portal can be embedded in virtually any electrical device.

FIG. 6 shows a stereo system 90 having various components such as a receiver, amplifier, etc. The stereo system 90 has disposed inside it an embedded powerline access portal 92. The embedded powerline access portal 92 is coupled directly to a power cord 94 that is plugged into wall socket 96. The stereo system is transmitting audio data to remote speakers 98 and 100. Remote speaker 98 includes embedded powerline access portal 102, which is coupled to power cord 104, which is plugged into wall socket 106. Remote speaker 100 includes embedded powerline access portal 108, which is coupled to power cord 110, which is plugged into wall socket 112.

Audio data is transmitted by the stereo system 90 and placed onto a common powerline by the embedded powerline access portal 92, or onto powerlines that are coupled at a power junction box. The audio data is received by the remote speakers 98, 100 from powerlines via their own embedded powerline access portals 102, 108.

It is important to recognize that the stereo system 90 example of FIG. 6 enables the stereo system 90 to be installed without running any audio cables. The stereo system 90 does not require a computer network to transport the audio data. The powerlines simply function as the data transport medium. The stereo system 90 is compact because all of the powerline access portals are integrated into the power supplies of the various audio components.

It should be recognized that the present invention is capable of providing precise control over audio data. For example, the stereo system 90 might be a 5.1 audio system, with 5 speakers and a subwoofer. It may be desirable to include some delay in audio signals in order to provide true surround sound, or to apply some other audio enhancement technique.

It should be apparent that it is also possible to send specific audio tracks to specific speakers in order to achieve this desired control over the audio reproduction capabilities of stereo system 90. This can be achieved through the assignment of a unique address to all powerline access portals. This would be similar to the MAC address assigned to network cards in use on the Internet today.

Modifications to the scenario of FIG. 6 would be to mix embedded powerline access portals with non-embedded devices. For example, remote speakers could be purchased that have the embedded powerline access portals. The remote speakers could be used with a stereo system that does not have the embedded powerline access portal. The stereo system could use an external powerline access portal, such as a wall wart of FIG. 2, a power strip of FIG. 3, or a desktop unit of FIG. 5. Thus, this mixing and matching of external and internal powerline access portals can be used for any electronic appliances.

Again, it should be emphasized that the present invention provides for generic data transport, and not transport of only computer or computer-related data. The transport medium and the powerline access portals can send any type of data that can be digitized and transmitted on powerlines.

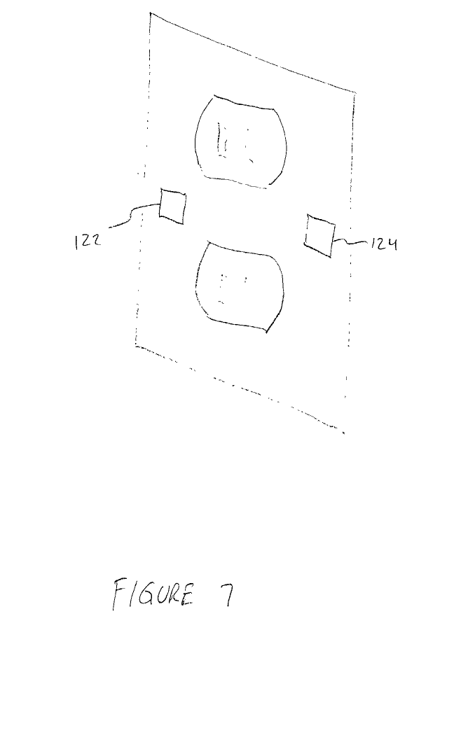

A last form factor to be discussed and shown in FIG. 7 is an integrated powerline access portal. FIG. 7 shows an electric wall socket 120, with two data ports 122, 124. These data ports 122, 124 can be formed to receive any type of desired data, such as computer network data, audio data, video data, control signals, and native communication signals. There can be a single data port, or multiple data ports.

This form factor of FIG. 7 may be more aesthetically pleasing, but possibly require the complete replacement of an electrical junction box behind the wall socket 120 in the wall. In an alternative embodiment, surge suppression and/or filtering could also be disposed in the wall.

Having set out several form factors of the present invention to include a powerline access portal disposed in a wall-mounted unit or wall wart, a power strip and/or surge suppressor, a desktop unit, an embedded unit, or an integrated wall unit, it is now useful to examine some issues that may not be apparent to a user but which are important aspects of the present invention. Some of these issues will be discussed in relation to more applications of the present invention.

It was mentioned previously that the present invention also includes the aspect of providing directional filtering where noise is prevented from entering into powerlines by electrically noisy appliances, such as a drill. The other filtering concept to now be addressed is filtering that can be used to manage the distance that data signals are to be transported along powerlines.

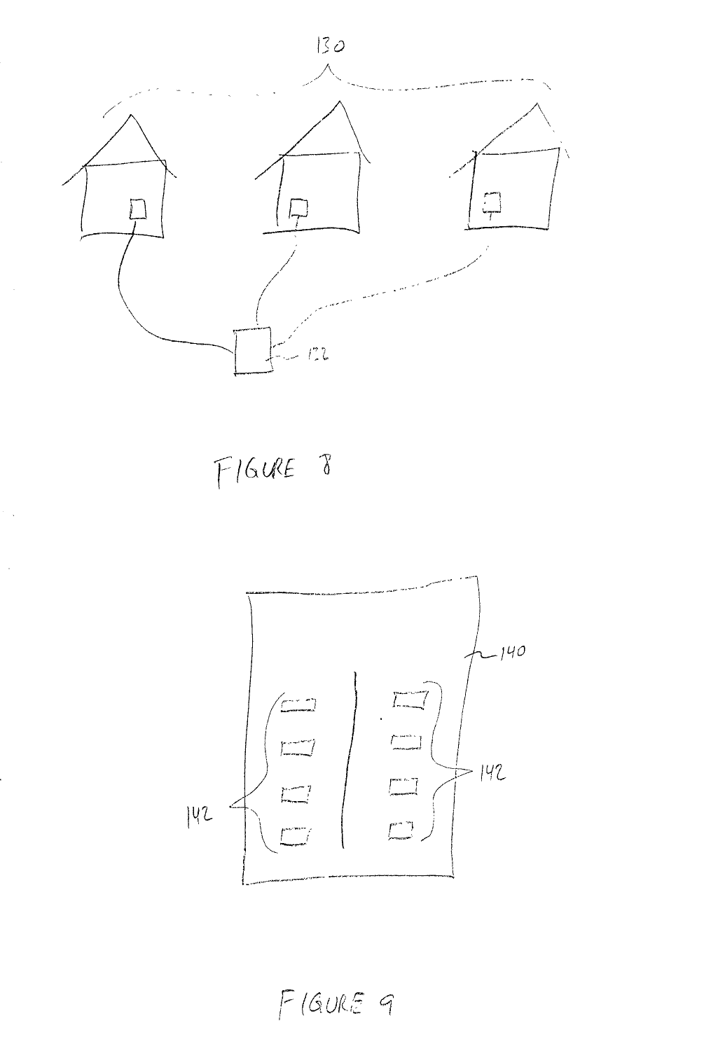

Consider first a group of homes as shown in FIG. 8. Typically, a group of homes 130 will all be connected to the same transformer 132 to receive electricity. The signal strength of the data being transported via powerlines may be strong enough, in certain circumstances, to travel to other homes 130 that are on the same side of the transformer 132. This is potentially a serious matter depending upon the type of data being transported. For instance, it may be computer network data that contains sensitive information, or video data from a surveillance camera.

In order to prevent the data from passing through the transformer 132 to another home, the present invention provides a filter that is installed at a power junction box.

It is appropriate to raise the analogous situations that will occur in office buildings or hotel environments. The cost savings of being able to network hotel rooms without having to install computer cabling would be large, especially in larger hotels. But the need to provide filtering would be very important when trying to isolate portions of computer networks from each other, and from a larger power grid. Thus, one particularly useful application of a filter is the ability to create electrically isolated segments of computer networks as will be explained.

A typical power junction box 140 is shown in FIG. 9. The power junction box 140 distributes electricity)throughout a house using switches 142 having fuses. The power junction box 140 is also typically divided into two halves. These sides may be electrically isolated from each other. An important aspect of the present invention is the installation of filter/fuses, or just filters. These filters would prevent data transport beyond, and thus ensure the privacy that is needed.

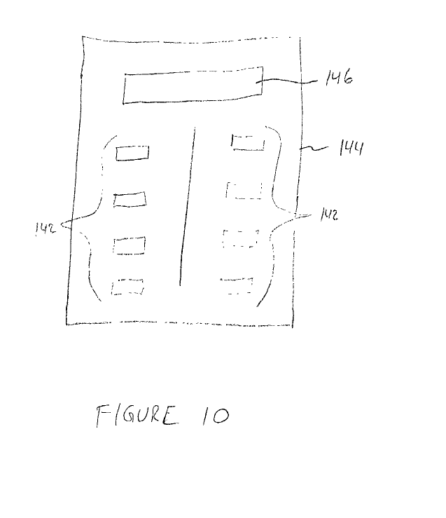

Another modification that may be useful at the power junction box 144 is shown in FIG. 10. In this figure, the power junction box 144 is still equipped with the filters that prevent data from being transported beyond the electrical system of the home. Now the power junction box 144 includes a network switch 146. The network switch 146 is designed to enable data transport beyond the powerlines of the home, but in an obviously controlled manner. The network switch 146 would include a connection to a global information network such as the Internet. The use of a network switch 146 would advantageously enable full bandwidth communication of each isolated segment of a home's or office's powerline data network.

There are numerous applications of the present invention that can be used in a home or office environment. For example, security is an excellent application of the technology. A room does not have to have any special wiring to have a video and/or audio system installed. Thus, such a system can be adapted as a baby monitor system, an intercom system, or a home voice system.

An intercom system would require a user to push a button to talk. In contrast, a home voice system would include some intelligence. Instead of broadcasting a voice to all rooms, the system can determine which room is to receive the signal.

One of the main advantages of the present invention is the inconspicuous manner in which the components of the present invention can be installed and distributed where desired. The present invention makes clear that wall outlets are easily coupled to in order to send and receive data via powerlines. However, there are many ways to distribute electrical power, and thus take advantage of data transport. For example, speakers can be inserted in track lighting suspended overhead on a ceiling. This would make audio enhancement very simple to do.

A small powerline access portal might even be combined with the track lighting itself. For instance, a small disk might be instead between a bulb and the socket. The disk is a small powerline access portal that might provide no more functionality than that of controlling the operation of the light. But in and of itself, that is an important aspect of the invention.

It was mentioned previously that control signals might also be transported via powerlines. One application of control signals is to send a signal that will turn lights on and off, control audio systems, intercoms, security systems, and television entertainment systems. Indeed, the present invention provides instant access to all rooms that have light sockets and power outlets, which is going to be most if not all rooms in a house or office.

Regarding control signals, an exciting new realm of controlling and monitoring all electrical appliances within range of data transport becomes possible. Consider a remote control unit in a living room. The remote control unit might transmit control signals in the infrared or as radio frequency signals. Suppose that the living room is equipped with an infrared receiver coupled to a powerline access portal that is coupled to a powerline. The infrared remote can be used to turn off the lights in the basement, turn on a stereo system in a den, and send the audio signal to speakers in an upstairs bedroom. This system may require that the room to which the control signal is being sent have a transmitter of the same type as the remote control unit. However, the transmitting device could use a different transmitting protocol or system. It is only important that a transmitter be located in a room that is capable of controlling the devices in the room it is located.

A security camera on the front porch sends its video signal to a monitor in the kitchen. A party is taking place in a family room, so the infrared remote sends a desired satellite television signal from a satellite receiver in a bedroom to the family room. Meanwhile, a video and audio signal from a DVD player in the den is routed to a television in another bedroom. Finally, a computer in the den is used to access the Internet and web browse. All of the data transport of computer network, audio, video, and audio/video signals is occurring simultaneously on the powerlines of a single house, and a single infrared remote control unit is routing signals, and powering electrical appliances and lights on and off. Thus, one aspect of the present invention is to consider every situation as selection of a source device, and selection of a destination device that will receive a data signal.

Another application of the present invention would be home monitoring devices such as smoke detectors or carbon monoxide detectors. In large homes, it is difficult to hear a basement alarm in an upstairs bedroom, especially when doors are closed. The detectors could not only sound an audible alarm where they are located, but also send a signal back though a powerline to some central device that could trigger the audible alarms on all of the detectors in the home to ensure that everyone is warned, regardless of proximity to the device that detected the problem.

It is another aspect of the invention to conceal devices within other devices. For example, a smoke detector might conceal a camera that is transmitting its video signal to a monitor via powerlines. This may be performed for security purposes, such as providing a homeowner with the ability to monitor the performance of a baby-sitter.

A final aspect of the invention is the ability to adapt to protocols in order to transport useful data. Consider the subject of what will be discussed hereinafter as common protocols, cross-protocols, and native protocols.

First, the present invention introduces the concept of protocols to mean that electrical appliances may have their own “native” data format or protocol that may or may not be associated with a specific type of cable. For example, a digital camcorder may transmit data via a USB or Firewire port via a USB or Firewire cable. Typically, a USB or Firewire cable is coupled to the digital camcorder, and then coupled to a computer.

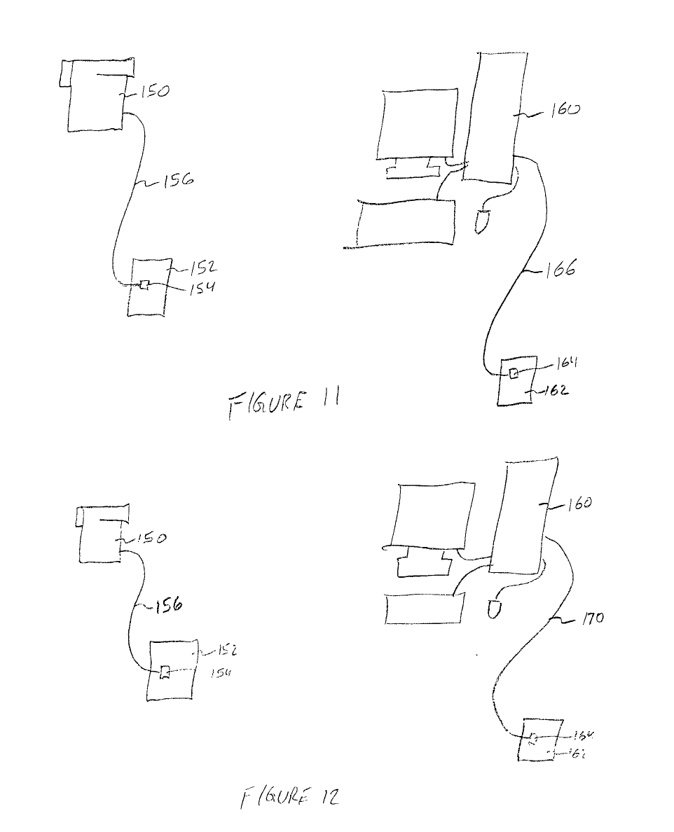

In FIG. 11, the present invention illustrates how it is possible to connect a digital camera 150 to a powerline access portal 152 at data port 154 via a Firewire cable 156, using its associated native protocol. Firewire data is then transported via powerlines to, for example, a computer 160 that is also coupled to a powerline access portal 162 through data port 164 via a Firewire cable 166. In this case, Firewire data is never being transformed other than for transport via powerlines. The data is always formatted as Firewire data. This would be data transport using native protocols.

However, consider the case where the digital camcorder 150 and the computer 160 are still coupled to their respective powerline access portals 152, 162 via the Firewire cables 156, 166. The powerline access portal in this embodiment includes the ability to translate data to a common protocol. In other words, no matter what type of native protocol is sent to the powerline access portal, it is transformed to a common protocol that is understood by all powerline access portals. And then at the receiving connection, the data is transformed back to the transmitted protocol and sent to its destination.

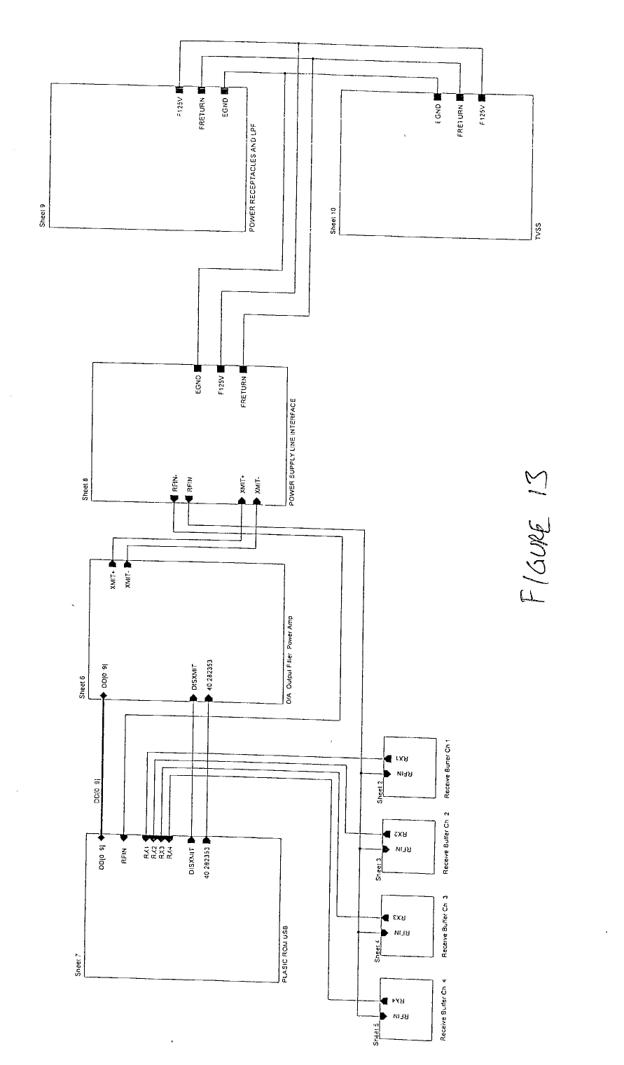

There are variations of this protocol theme as well. In FIG. 12, the source device is the digital camcorder 160, and data is transmitted using the Firewire protocol. However, at a receiving location, the computer 160 might not be equipped with a Firewire cable. Instead, the computer 160 has an Ethernet cable 170. The powerline access portal would transform the Firewire protocol to an Ethernet protocol suitable for transmission to the computer 160. This is an example of cross protocols, where each device is sending and receiving data in its own desired protocol, and the powerline access portal provides the necessary protocol translation or transformation capabilities to enable communication.

The remaining figures that are included with this document are provided in order to show one example of an implementation of the present invention. These circuit schematics should not be considered limiting, but are an enabling example that can be used by those skilled in the art to practice and make the modifications of the present invention as disclosed herein.

FIG. 13 shows a schematic of a powerline bridge integrated circuit (MAC/PHY) and related components used by the powerline bridge to communicate data onto and off of a powerline. The figure shows the interrelationship of the processor, the buffers, the output filter, the power amp, the power supply line, the powerline interface, the power receptacles, etc.

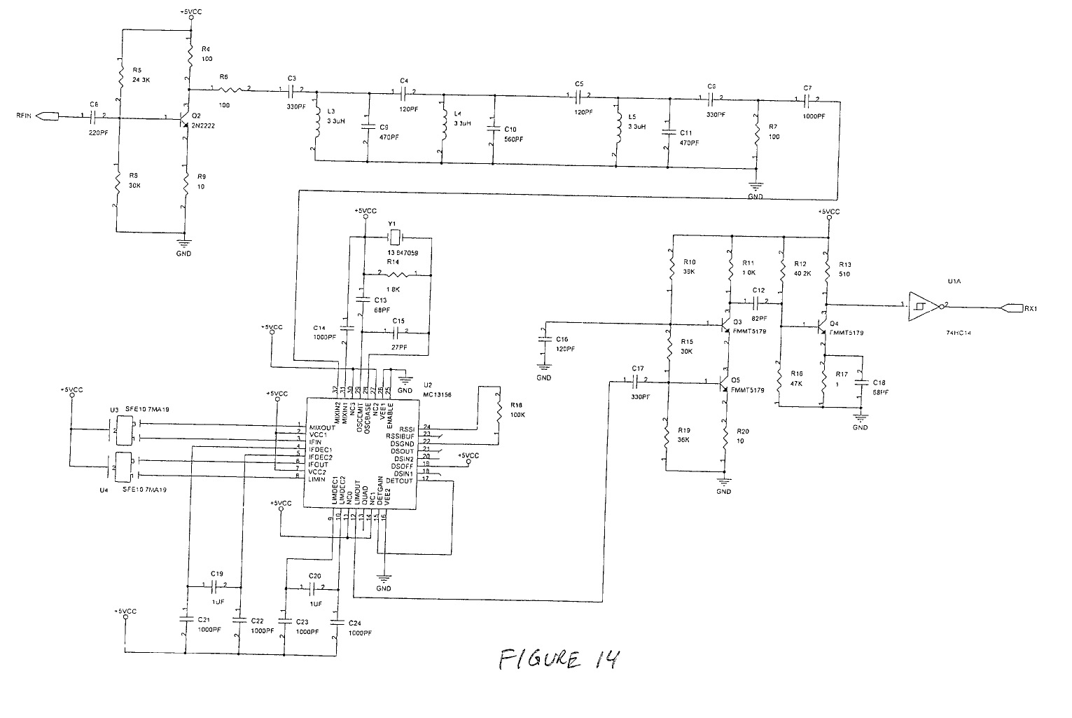

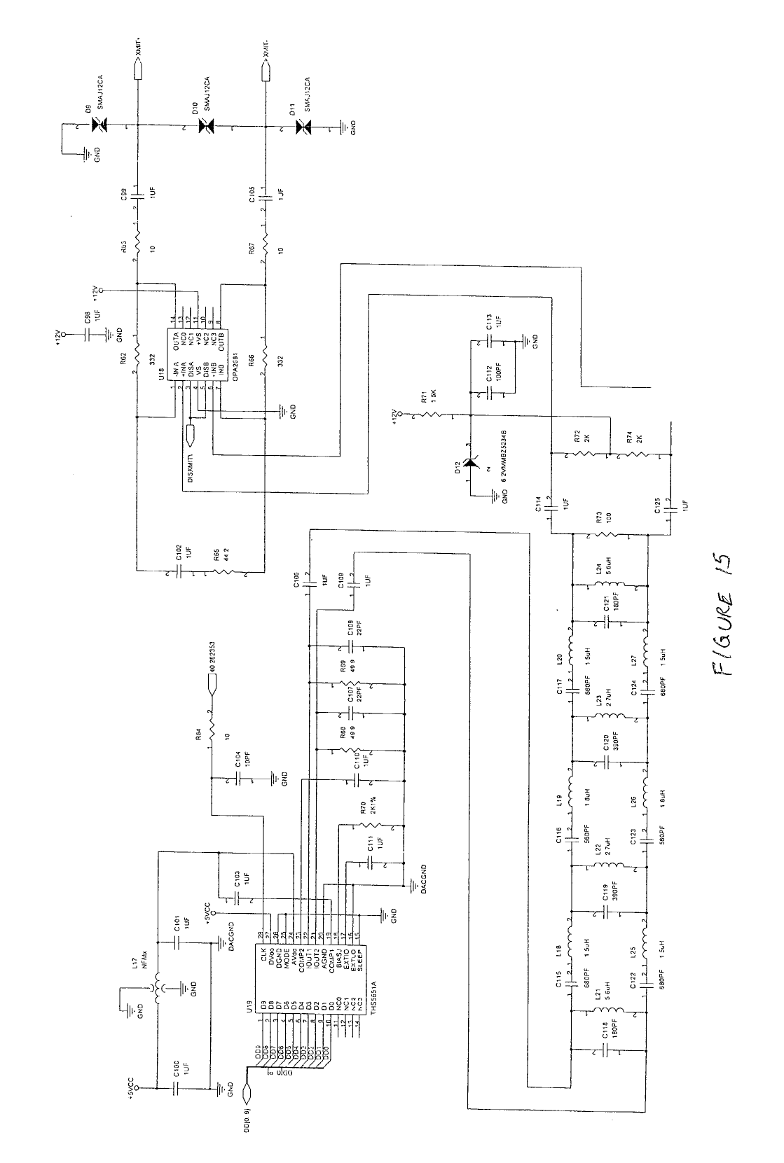

FIG. 14 shows a schematic of the receive buffers for filtering and modulating signals for channel one. Those skilled in the art will appreciate that the receive buffers for channels 2 through 4 can be configured accordingly.

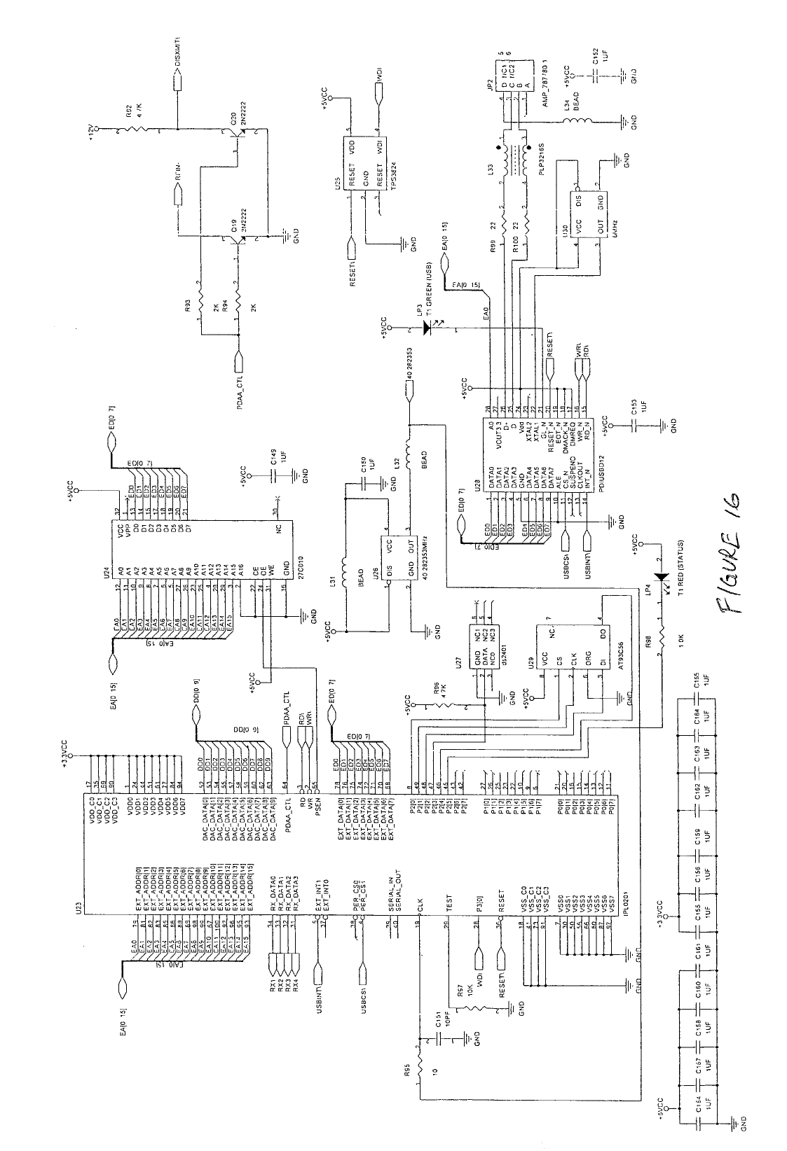

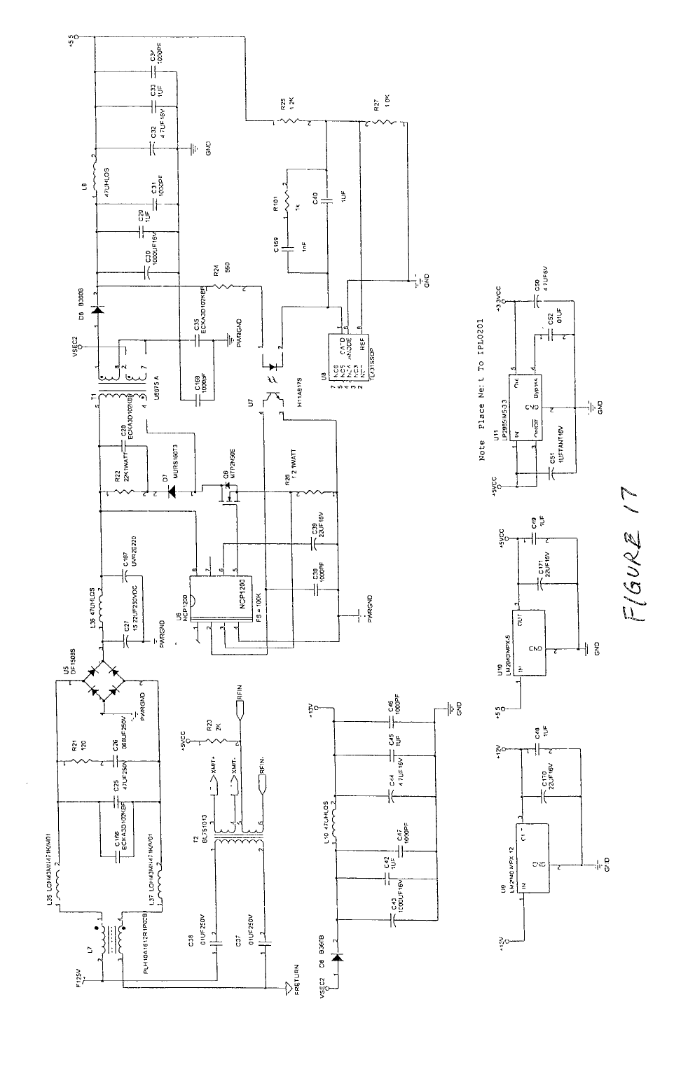

FIG. 15 shows a schematic of the output filter and power amp that are disposed in communication with the powerline bridge integrated circuit that is shown in FIG. 16.

FIG. 16 is a schematic diagram that illustrates the powerline bridge integrated circuit.

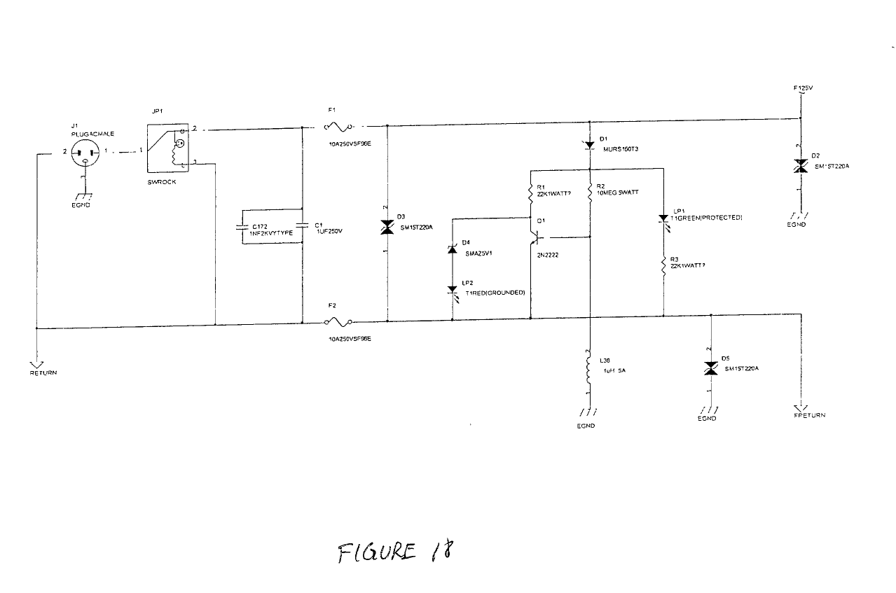

FIG. 17 is a schematic of the power supply and the powerline interface.

FIG. 18 is a schematic diagram of transient voltage surge suppressors and LEDs informing the user of the status of power and if earth ground is connected to the power strip.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A powerline access portal system for enabling transfer of data onto and off of a powerline, said system comprised of:
an electrical outlet connector that is coupled to a powerline;
a media access controller/physical interface (MAC/PHY) processor that transforms data that is to be transported via the powerline, and that transforms data that has been transported and received from the powerline;
an analog front end coupled between the electrical outlet and the MAC/PHY processor that is capable of amplifying signals to be transmitted on or received from the powerline; and
a data transport interface coupled to the MAC/PHY processor that sends data to the MAC/PHY processor for transport by the powerline, and that receives data from the MAC/PHY processor that has been transported and received from the powerline.

2. The powerline access portal system as defined in claim 1 wherein the data transport interface is selected from the group of data protocols including universal serial bus (USB) 1.0, USB 2.0, parallel, serial, Firewire, fiber optical, telephony, digital subscriber line (DSL), WiFi 802.11a, 802,11b, Bluetooth, radio frequency signals, and infra-red.

3. The powerline access portal system as defined in claim 2 wherein the system further comprises a protocol translator for translating between various data protocols in order to transmit and receive any desired data protocol.

4. The powerline access portal system as defined in claim 3 wherein the system further comprises:
a housing, wherein the system is disposed within the housing, and wherein the housing is designed as a wall mounted unit that is electrically and physically coupled to an electrical wall outlet; and
at least one data port disposed on the housing to enable at least one data connection to be made with the system via the data transport interface.

5. The powerline access portal system as defined in claim 4 wherein the system further comprises a plurality of data ports disposed in the housing to enable a plurality of connections to the system via the data transport interface.

6. The powerline access portal system as defined in claim 5 wherein the system further comprises a visual indicator light, wherein the visual indicator light provides visual feedback regarding at least one aspect of operation of the system.

7. The powerline access portal system as defined in claim 4 wherein the housing further comprises a plurality of electrical sockets for providing electrical power.

8. The powerline access portal system as defined in claim 7 wherein the plurality of electrical sockets further comprise at least one filter for preventing electrical noise from entering the powerline.

9. The powerline access portal system as defined in claim 3 wherein the system further comprises:
a housing, wherein the system is disposed within the housing;
a power strip disposed within the housing, the power strip including at least one electrical socket that provides electrical power; and
at least one data port disposed on the housing to enable at least one data connection to be made with the system via the data transport interface.

10. The powerline access portal system as defined in claim 9 wherein the system further comprises a plurality of data ports disposed in the housing to enable a plurality of connections to the system via the data transport interface.

11. The powerline access portal system as defined in claim 10 wherein the system further comprises a visual indicator light, wherein the visual indicator light provides visual feedback regarding at least one aspect of operation of the system.

12. The powerline access portal system as defined in claim 11 wherein the housing further comprises a plurality of electrical sockets for providing electrical power.

13. The powerline access portal system as defined in claim 12 wherein the plurality of electrical sockets further comprise at least one filter for preventing electrical noise from entering the powerline.

14. The powerline access portal system as defined in claim 3 wherein the system further comprises:
a housing, wherein the system is disposed within the housing;
a power supply that is external to the housing, and wherein the power supply is coupled to the housing via an electrical cable; and
at least one data port disposed on the housing to enable at least one data connection to be made with the system via the data transport interface.

15. The powerline access portal system as defined in claim 14 wherein the system further comprises a plurality of data ports disposed in the housing to enable a plurality of connections to the system via the data transport interface.

16. The powerline access portal system as defined in claim 15 wherein the system further comprises a visual indicator light, wherein the visual indicator light provides visual feedback regarding at least one aspect of operation of the system.

17. The powerline access portal system as defined in claim 3 wherein the system further comprises:
an electrical appliance;
a power supply disposed within the electrical appliance for supplying power to the electrical appliance, the system being disposed within the electrical appliance between the power supply for the electrical appliance and an electrical outlet; and
at least one data port on the system to enable at least one data connection to be made between the system and the electrical appliance via the data transport interface.

18. The powerline access portal system as defined in claim 17 wherein the system further comprises a plurality of data ports to enable a plurality of connections between the electrical appliance and the system via the data transport interface.

19. The powerline access portal system as defined in claim 18 wherein the system further comprise at least one filter for preventing electrical noise from entering the powerline from the electrical appliance.

20. The powerline access portal system as defined in claim 3 wherein the system further comprises:
a housing, wherein the system is disposed within the housing, and the housing is an integral part of an electrical box disposed within a wall, floor, or ceiling;
at least one electrical socket disposed on the housing for providing electrical power; and
at least one data port disposed on the housing to enable at least one data connection to be made with the system via the data transport interface.

21. The powerline access portal system as defined in claim 20 wherein the system further comprises a plurality of data ports disposed in the housing to enable a plurality of connections to the system via the data transport interface.

22. The powerline access portal system as defined in claim 21 wherein the system further comprises a visual indicator light, wherein the visual indicator light provides visual feedback regarding at least one aspect of operation of the system.

23. The powerline access portal system as defined in claim 22 wherein the housing further comprises a plurality of electrical sockets for providing electrical power.

24. The powerline access portal system as defined in claim 23 wherein the plurality of electrical sockets further comprise at least one filter for preventing electrical noise from entering the powerline.

25. The powerline access portal system as defined in claim 24 wherein the system further comprises a visual indicator light, wherein the visual indicator light provides visual feedback regarding at least one aspect of operation of the system.

26. The powerline access portal system as defined in claim 24 wherein the system further comprises:
at least one powerline;
a power junction box coupled to the at least one powerline; and
at least one fuse disposed in the power junction box on the at least one powerline, wherein the at least one fuse operates to isolate data that may be transported on the at least one powerline from all other powerlines that meet at the power junction box.

27. The powerline access portal system as defined in claim 26 wherein the power junction box further comprises a computer network switch to thereby enable data on the at least one powerline to be transported to a global information network.

28. A method for enabling transfer of data onto and off of a powerline utilizing a powerline access portal, said method comprising the steps of:
1) providing a powerline access portal that comprises an electrical outlet connector that is coupled to a powerline, a media access controller/physical interface (MAC/PHY) processor that transforms data that is to be transported via the powerline, and that transforms data that has been transported and received from the powerline, an analog front end coupled between the electrical outlet and the MAC/PHY processor that is capable of amplifying signals to be transmitted on or received from the powerline, and a data transport interface coupled to the MAC/PHY processor that sends data to the MAC/PHY processor for transport by the powerline, and that receives data from the MAC/PHY processor that has been transported and received from the powerline; and
2) transmitting data to the data transport interface to be transported via the powerline.

29. The method as defined in claim 28 wherein the method further comprises the step of receiving data from the data transport interface, wherein the data has been transported to the data transport interface via the powerline.

30. A method for transferring data via powerline utilizing a powerline access portal, said method comprising the steps of:
1) providing a powerline access portal that is coupled to a powerline; and
2) transmitting data via the powerline access portal to the powerline, wherein the data is characterized as being selected from the group of data types comprised of Ethernet, USB 1.0 and 2.0, parallel, serial, Firewire (IEEE 1394), optical (fiber optic), telephony, DSL, WiFi 802.11a, 802.11b, Bluetooth, and radio frequency 900 MHz), and infra-red.

31. The method as defined in claim 30 wherein the method further comprises the step of receiving data via the powerline access portal that has been transmitted via the powerline, wherein the data is characterized as being selected from the group of data types comprised of Ethernet, USB 1.0 and 2.0, parallel, serial, Firewire (IEEE 1394), optical (fiber optic), telephony, DSL, WiFi 802.11a, 802.11b, Bluetooth, and radio frequency 900 MHz), and infra-red.

32. The method as defined in claim 31 wherein the method further comprises the steps of:
1) transmitting data via from a first device to a first powerline access portal, wherein the data is transmitted via a native data protocol;
2) transmitting the data formatted in the native protocol from the first powerline access portal to the powerline;
3) receiving the data formatted in the native protocol from the powerline at a second powerline access portal; and
4) receiving the data formatted in the native protocol from the second powerline access portal at a second device.

33. The method as defined in claim 31 wherein the method further comprises the steps of:
1) transmitting data via from a first device to a first powerline access portal, wherein the data is transmitted via a native data protocol;
2) transforming the data from the native protocol to a common protocol;
3) transmitting the data formatted in the common protocol from the first powerline access portal to the powerline;
4) receiving the data formatted in the common protocol from the powerline at a second powerline access portal;
5) transforming the data from the common protocol to the native protocol; and
6) receiving the data formatted in the native protocol from the second powerline access portal at a second device.

34. The method as defined in claim 31 wherein the method further comprises the steps of:
1) transmitting data via from a first device to a first powerline access portal, wherein the data is transmitted via a first native data protocol;
2) transmitting the data formatted in the first native protocol from the first powerline access portal to the powerline;
3) receiving the data formatted in the first native protocol from the powerline at a second powerline access portal;
4) transforming the data from the first native protocol to a second native protocol; and
5) receiving the data formatted in the second native protocol from the second powerline access portal at a second device.

35. The method as defined in claim 31 wherein the method further comprises the steps of:
1) providing a first device in a first location, wherein the first device generates data selected from the group of data types comprised of computer network data, audio data, video data, control signal data, native communication signal data, and any combinations thereof;
2) transmitting the data from the first device to the powerline via a first powerline access portal;
3) receiving the data from the powerline at a second powerline access portal; and
4) providing a second device in a second location, wherein the second device receives the data from the second powerline access portal.

36. The method as defined in claim 35 wherein the method further comprises the step of providing a control signal transmitter at the first location, wherein the control signal transmitter is capable of transmitting at least one control signal that can control at least one operation of the first device.

37. The method as defined in claim 36 wherein the method further comprises the step of providing a control signal receiver at the second location, wherein the control signal receiver is capable of receiving at least one control signal that can control at least one operation of the first device.

38. The method as defined in claim 37 wherein the method further comprises the steps of:
1) transmitting at least one control signal from the second location to the first location; and
2) controlling at least one operation of the first device from the second location.

39. The method as defined in claim 38 wherein the method further comprises the steps of:
1) selecting a source device that can receive a control signal that can be transmitted via the powerline; and
2) selecting a destination device that can receive data transmitted from the source device via the powerline.

40. The method as defined in claim 39 wherein the method further comprises the step of transmitting the control signal that causes the source device to transmit data to the destination device.

41. The method as defined in claim 40 wherein the source device is selected from the group of source devices comprised of computer systems, lights, audio systems, intercom systems, security systems, and video systems.
